(19) United States
(12) Patent Application Publication
(10) Pub. No.: US 2002/0129712 A1
(43) Pub. Date: Sep. 19, 2002

(54) Beverage brewing system

(75) Inventors: Anne Marie Westbrook, Mason, OH (US); David Andrew Dalton, Loveland, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Co.

(21) Appl. No.: 10/098,579

(22) Filed: Mar. 15, 2002

Related U.S. Application Data
(60) Provisional application No. 60/276,554, filed on Mar. 16, 2001.

(51) Int. Cl. A47J 31/00

(52) U.S. Cl. 99/279; 99/302 R; 99/286; 99/280

(57) ABSTRACT

The present disclosure relates to beverage brewing systems which are useful for preparing fresh brewed beverages from a beverage brewing device. In particular, the present invention relates a brewing system comprising a system controller for directing the operation of a fluid reservoir, pump, heater, a fluid direction mechanism, fluid insertion devices, and a user interface. Optionally, the system may provide a fluid purification device. Theses systems are especially advantageous in the preparation of brewed coffee beverages.

### CROSS REFERENCE TO RELATED APPLICATIONS

This application claims priority to U.S. Provisional Application No. 60/276,554, filed Mar. 16, 2001.

### FIELD OF THE INVENTION

The present invention relates to systems for preparing brewed beverages. In particular, the present invention relates to inexpensive, convenient, easy to use systems for preparing single serving portions of brewed beverages from beverage brewing devices.

### BACKGROUND OF THE INVENTION

Brewed beverages such as coffee, tea, cocoa, and the like enjoy considerable popularity amongst consumers both at home and in away from home markets such as at restaurants, cafes, and other specialty beverage shops. Consumers enjoy the high quality these beverages possess, resulting in part from the freshness of the beverage; the consistency from cup to cup; and, the variety of coffees, coffee blends, and other ingredients available.

Consumers are also attracted to the convenience that these café quality beverages posses. Notably, consumers are able to obtain a single serving portion of a desired beverage, which is typically prepared and available in a brief amount of time (e.g., 2 minutes or less). From the perspective of the consumer these beverages are also prepared and disposed of with little or no mess. Consumers especially prefer the ability to customize their brewed beverages for such variables as strength, character, volume, and optional ingredients, without compromising either quality and convenience. Considerable attention, therefore, has been directed in the art towards providing brewing systems capable of producing these high quality, convenient, customizable brewed beverages at home, but have thus far met with limited success.

One such approach to providing brewing systems capable of producing the desired café quality brewed beverages has been the simple modification, miniaturization, and/or importation of costly and complex brewing equipment into the home. See U.S. Pat. No. 4,809,594, to Vitous et al., issued Mar. 7, 1989; U.S. Pat. No. 5,083,503, to van Hattem et al., issued Jan. 28, 1992; and U.S. Pat. No. 5,123,335, to Aselu et al., issued Jun. 23, 1992. These approaches, however, have met with limited success. The cost of these modified, industrial systems has prevented wide spread consumer acceptance. Moreover, the systems' complexity has done little to satisfy the consumer's desire for convenience.

The art has attempted to address the problems of system complexity, cost and lack of convenience but has also met with limited success. These low cost systems have failed to gain wide spread acceptance because of their inability to provide the quality and customizability that consumers seek.

Considerable effort, therefore, has been expended in an attempt to address the consumer acceptance limitations of existing approaches in the art. However, there remains a need in the art for apparatuses, compositions, and methods for delivering consistent, café quality, customizable, and convenient beverage brewing systems at home, that are both economical and easy to use. Accordingly, it is an object of the present invention to provide apparatuses, compositions, and methods which address these needs and provide further related advantages.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic diagram of the components of one embodiment of the present invention.

FIGS. 2-7 are perspective views of various embodiments of the beverage brewing systems of the present invention.

FIGS. 8-11 are perspective views of various user interfaces on the beverage brewing systems of the present invention.

### A. DEFINITIONS

As used herein, the terms “first,” “second,” “third,” and the like are utilized to refer to, for example, the identity of various components and chambers. It will be recognized by the ordinarily skilled artisan upon reading the disclosure therein that these terms are used for convenience only, and are not meant to indicate order of importance, sequence, physical location within the beverage device, or other such characterizations.

As used herein, the term “beverage preparation time” is defined as the time from the first moment of fluid introduction to the beverage extraction chamber to the moment a sufficient amount of extract has exited the brewing device such that the beverage has the desired volume, strength, and character.

As used herein, the term “fluidized extraction environment” is defined as an environment wherein during extraction the beverage ingredients are capable of fluidizing (i.e., to be suspended in a liquid so as to induce flowing movement of the total ingredient mass).

As used herein, the term “proximately or fluidly connected” is defined as either integral, directly adjacent, directly connected, or connected by some form of tube, channel, conduit, chamber, passage, and the like that allows the migration of fluid from one location to another.

As used herein, the term “extraction headspace volume” is defined as the void volume within the ingredient extraction chamber that exists during extraction. It is the volume of space above the non-tamped, dry bulk ingredient volume.

As used herein, the term “non-tamped, dry bulk ingredient volume” is defined as the volume of the dry ingredients, prior to wetting and/or extraction.

As used herein, the term “fluid” is defined as including both the liquid and gaseous forms of a substance.

As used herein, the terms “brewing” and “extraction” are used interchangeably and are defined as the process of mass transfer of materials from the bulk ingredient to the extraction liquid. As used herein, the terms “brewing” and “extraction” are also defined as including the rehydration, solubilization, and dissolution of dry solids.

Publications and patents are referred to throughout this disclosure. All references cited herein are hereby incorporated by reference.

All percentages and ratios are calculated by weight unless otherwise indicated. All percentages and ratios are calculated based on the total composition unless otherwise indicated.

All component or composition levels are in reference to the active level of that component or composition, and are exclusive of impurities, for example, residual solvents or by-products, which may be present in commercially available sources.

As used herein, the total amount of any given component includes any added component as well as any of the components inherently present in the composition by virtue of inclusion of additional ingredients in the composition.

Referred to herein are trade names for certain articles and compositions, including the trade names for various ingredients utilized in the present invention. The inventors herein do not intend to be limited by the exact composition or formulation of a particular material identified by a specific trade name. Equivalent materials (e.g., those obtained from a different source under a different name or catalog number) to those referenced by a given trade name may be substituted and utilized in the compositions, kits, and methods herein.

In the description of the invention various embodiments and/or individual features are disclosed. As will be apparent to the ordinarily skilled practitioner upon reading the disclosure herein, all combinations of such embodiments and features are possible and can result in preferred executions of the present invention.

### B. BEVERAGE BREWING DEVICE

The beverage brewing devices of the present invention are designed to provide an, individual serving portion of a fresh brewed, customizable brewable beverage composition. Brewable beverages include beverages such as coffee, tea, cocoa, and the like, including mixtures thereof. Though the present invention may be used in conjunction with numerous types of brewable beverages, the present invention will be described primarily with respect to coffee. One of ordinary skill in the art will appreciate that this is done simply for the convenience of the reader and is not intended to be limiting.

It is contemplated by the inventors that by using the present beverage brewing devices the consumer does not need to obtain a variety of ingredients and/or perform extensive preparation to prepare a desired, customized beverage. As such, the beverage brewing devices are particularly useful in the private home environment, although their use is not limited to that environment. Accordingly, the brewing devices will also be useful in, for example, institutions and restaurants a variety of individually customized beverages may be required at or about the same time.

In one set of embodiments of the present invention the beverage brewing devices comprise a plurality of extraction chambers (i.e., two or more) wherein each extraction chamber contains one or more components or ingredients as defined herein. These beverage brewing devices are particularly useful for the preparation of beverages where the strength, character, volume or other characteristics such as flavors, creaminess, and the like may be varied.

Typically, the beverage brewing devices of the present invention are disposable devices that are suitable for use in connection with a brewing system, such as a traditional coffee brewer or other systems described herein. As used herein, the term “disposable” with reference to a beverage brewing device means that the beverage brewing device is intended for single or other limited usage, such that the beverage brewing device is disposed of subsequent to using the device a single time or a minimal number times (usually no more than about three times). Most preferably, the beverage brewing device is intended for single use only. Where the beverage brewing device is intended for single use only, the brewing device is intended for disposal subsequent to the first use of the device.

Preferably, the beverage brewing devices described herein are intended to work in conjunction with a beverage brewing system. Suitable beverage brewing systems for use with the instant beverage brewing devices can be found in co-pending Procter & Gamble Case No. 8469M, filed Mar. 15, 2001 in the name Candido et al., titled “Beverage Brewing Systems,” which is herein incorporated by reference.

The brewing devices of the present invention comprise a housing in which one or more ingredient extraction chambers are located. Disposed on the housing is a fluid introduction site, through which fluid from the beverage brewing system is introduced to an ingredient extraction chamber. The fluid mixes with the beverage ingredients to form a beverage extract. Proximately or fluidly connected to the ingredient extraction chamber is a filter. By “proximately or fluidly connected” it is met that the fluid passes either directly from one described component or assembly of the beverage brewing device to another. The term proximately or fluidly connected is also meant to encompass passing from one described component or assembly to another via a channel, conduit, passage, tube, or other such similar means.

The beverage extract from the ingredient extraction chamber passes through a filter to remove undesirable suspended solids, and/or excess amounts of materials that in limited quantities would be preferred, from the extract solution. After passing through the filter media the extract exits the beverage brewing device, through the housing, at an extract exit site. Prior to exiting the beverage brewing device the device may optionally collect in an extract collection chamber. The optional extract collection chamber is proximately or fluidly located between the filter media and the extract exit site.

(i) Housing

The beverage brewing devices of the present invention comprise a housing, The housing in use may be exposed directly to the atmosphere and have at least a portion in physical contact with the beverage brewing system. The housing encloses the various chambers, conduits, channels, components, assemblies, and sub-assemblies of the brewing device.

Depending on the exact configuration of the beverage brewing device an interior surface of the housing may form at least a portion of the walls, partitions, and enclosures of the various chambers, conduits, channels, components, assemblies, and sub-assemblies of the brewing device.

The housing may be constructed of a rigid, semi-rigid, or non-rigid material, or combinations thereof. Suitable materials include, but are not limited to, plastics, PET, foil, film, paper, and the like. The beverage brewing device, housing, and various chambers, conduits, channels, components, assemblies, and sub-assemblies can be formed from a variety of methods depending the exact configuration desired. Suitable methods include, but are not limited to, thermoforming, injection molding, and combinations thereof.

Preferably, the configuration of the brewing device housing is selected to be gas and moisture impermeable, such that the interior of the beverage brewing device and the corresponding ingredients are protected from exposure to the outside atmosphere. This ensures that the freshness and integrity of the ingredients contained within the beverage brewing device are preserved.

Alternatively, and equally preferable, the freshness and integrity of the enclosed ingredients is preserved by enclosing the beverage brewing device in a gas and/or moisture impermeable mother bag. In such circumstances it is not necessary that the beverage brewing device itself also be gas and/or moisture impermeable.

(ii) Fluid Introduction Site

The fluid introduction site is a region or location on the housing where brewing fluid (typically water in the temperature range of from about 150° F. to about 210° F.) enters the beverage brewing device. The fluid introduction site is proximately or fluidly connected to one or more ingredient extraction chambers. As used herein, the term “proximately or fluidly connected” is defined as either directly adjacent or connected by some form of tube, channel, conduit, chamber, passage, and the like that allows the flow of fluid from one location to another.

The fluid introduction site can either be formed by the beverage brewing system after introduction of the beverage brewing device to the beverage brewing system (e.g., by tearing, piercing, dissolving, crushing, pinching, bending, puncturing, and the like); formed during construction or assembly of the beverage brewing device and its components and subassemblies; formed by the user (e.g., by removal of a tear strip, puncturing, and the like); or by some combination thereof.

The fluid introduction site may be proximately or fluidly connected to the ingredient extraction chamber, such as where a portion of the housing forms at least a portion of one of the walls of the ingredient extraction chamber, or my be fluidly connected, for example by some form of tube, channel, conduit, chamber, passage, and the like that allows the flow of fluid from fluid introduction site to the ingredient extraction chamber.

The exact number and placement of fluid introduction sites on the housing is dependant on the particular design of the beverage brewing device. A brewing device having a single ingredient extraction chamber may necessitate only one fluid introduction site. However, the geometry of the ingredient extraction chamber and location within the beverage brewing device, amongst other variables, may make it preferable to have multiple fluid introduction sites. This may be done for a variety of reasons, for example, to aide in the delivery of a given volume of brewing fluid to the extraction chamber within a given amount of time; to aide in the mixing, dissolution, solubilization, and/or extraction of ingredients; or combinations thereof.

In beverage brewing devices comprising multiple ingredient extraction chambers there may be one fluid introduction site that is fluidly connected to the various ingredient extraction chambers. Alternatively, the single fluid introduction site could be proximately connected to at least one of the multiple ingredient extraction chambers and fluidly connected to the remainder.

In alternate embodiments, beverage brewing devices comprising multiple ingredient extraction chambers may preferably have more than one fluid introduction sites. In such embodiments, a fluid introduction site may be proximately connected to each ingredient extraction chamber, or each ingredient extraction chamber could have more than one fluid introduction site that is proximately or fluidly connected to it, and the like.

(iii) Ingredient Extraction Chamber

The beverage brewing devices of the present invention comprise one or more ingredient extraction chambers. The ingredient extraction chamber is constructed so as to provide a fluidized extraction environment. As used herein, the term “fluidized extraction environment” is defined as an environment wherein during extraction the beverage ingredients are capable of fluidizing (i.e., to be suspended in a liquid so as to induce flowing movement of the total ingredient mass).

It has been found that fluidization of the ingredients allows for higher degrees of extraction and/or solubilization of the ingredients resulting from increased surface activity of the ingredient particles. Additionally, a fluidized brewing environment (as opposed to a packed bed brewing environment, obviates the need for the costly, inconvenient, and complex high pressure brewing systems currently used in the art.

During normal operations the beverage brewing devices of the present invention are subjected to a maximum pressure during any stage of the brewing process of less than about 20 psig, preferably less than about 15 psig, preferably less than about 10 psig, more preferably less than about 5 psig. During normal operation, the maximum pressure experienced in the ingredient extraction chamber during the extraction phase is less than about 7 psig, preferably less than about 5 psig, preferably less than about 3 psig, more preferably less than about 1 psig. Optionally, at a point subsequent to extraction (i.e., after about 90% of the extractable materials required to make the particular desired beverage are extracted from the ingredients) the beverage brewing system will purge the beverage brewing device of remaining desirable particles and beverage components with a brief blast of hot fluid (e.g., hot water and/or steam).

During the optional purging step, the pressure in the ingredient extraction chamber is greater than the pressure during extraction, however, the pressure will be less than about 20 psig, preferably less than about 15 psig, preferably less than about 10 psig, more preferably less than about 5 psig. The use of a purging fluid (i.e., hot water and/or steam) in the beverage brewing device can also be employed to aide in the creation of foam in the finished beverage.

The movement and suspension of the ingredient particles permit them to be quickly and easily surrounded by the brewing liquid, thereby facilitating extraction and/or dissolution. Moreover, fluidized brewing greatly decreases the occurrence of disadvantageous channeling that is commonly observed in other methods of brewing.

Employment of a fluidized brewing environment in the ingredient extraction chamber has also been found to aide in the rapid extraction and/or solubilization of the various ingredients, as measured by beverage preparation time. Preferred beverage preparation times are less than about 120 seconds, more preferably less than about 90 20 seconds, more preferably less than about 75 seconds, more preferably less than 60 seconds.

Proper fluidization of the ingredient extraction chamber is accomplished by providing a suitable ingredient extraction chamber geometry during the extraction phase.

Suitable ingredient extraction chambers are those that have a ratio of total ingredient extraction chamber volume during extraction to non-tamped, dry bulk ingredient volume in excess of about 1.0:1.0. Preferably in excess of about 1.2:1.0, more preferably in excess of about 1.3:1.0, more preferably in excess of about 1.4:1.0, more preferably in excess of about 1.5:1.0. Both the total ingredient extraction chamber volume and the non-tamped, dry bulk ingredient volume can be measured using any suitable measure of volume, including cubic centimeters.

Alternatively, a suitable fluid extraction chamber geometry for fluidized extraction can be expressed as the ratio of extraction chamber head space volume to non-tamped, dry bulk ingredient volume. Preferably the ratio of extraction chamber head space volume to non-tamped, dry bulk ingredient volume is in excess of about 0.1:1.0. More preferably the ratio is in excess of about 0.25:1.0, more preferably in excess of about 0.5:1.0. Both the head space volume and the non-tamped, dry bulk ingredient volume can be measured using any suitable measure of volume, including cubic centimeters.

Relatively early in the brewing phase of fluidized brewing it is important to place a sufficient volume of brewing fluid (e.g., flooding the ingredient extraction chamber so that the ingredient particles are allowed to expand and float within the flooded chamber) into the ingredient extraction chamber to insure proper extraction and/or solubilization of the ingredients. This is done prior to the exiting of the resulting extract from the ingredient extraction chamber, which is accomplished by maintaining a flow rate of brewing fluid into the ingredient extraction chamber that is greater than the flow rate out of the chamber.

In the fluidized brewing environment of the present invention, once a sufficient volume of brewing fluid has entered the ingredient extraction chamber (e.g., a hydrostatic condition has been obtained and/or the head pressure within the chamber is greater than or equal to the pressure drop across the filter media at a point during maximum ingredient extraction chamber volume) then the flow rate of fluid into the chamber will equal the flow rate of resulting extract out of the chamber.

The various containment walls of the ingredient extraction chamber can be comprised of rigid, semi-rigid, or non-rigid materials, including combinations thereof. The various containment walls of the ingredient extraction chamber may change their shape and/or rigidity, depending on the material selected and the given stage within the brewing process. By way of example, at least a portion of the ingredient extraction chamber containment wall(s) may be of a given shape and rigidity during transportation and storage of the beverage brewing device. However, during or immediately following the introduction of the brewing fluid that portion of the containment wall(s) becomes less rigid and changes shape so as to increase the total volume of the ingredient extraction chamber during brewing.

One or more portions of the containment walls that define the region of the ingredient extraction chamber may be comprised of other beverage brewing device components, compartments, chambers, assemblies, and sub-assemblies. For example, the filter media may comprise one portion of the ingredient extraction chamber, where the beverage brewing device housing may comprise yet another portion.

(iv) Filter Media

The beverage brewing devices of the present invention comprise a filter media to remove undesirable insoluble particles from the ingredient extract prior to inclusion in a final beverage composition. The filter media is proximately or fluidly located between the ingredient extraction chamber and the extract collection chamber.

The filter media can be constructed from a variety of materials including, but not limited to, plastic, foil, non-woven polyester, polypropylene, polyethylene, paper materials, and combinations thereof. The filter media comprises one or more filtering orifices that allow the free passage of an extract solution, while simultaneously preventing the passage of a significant amount (i.e., in excess of 90%) of dispreferred insoluble ingredient particles and contaminants.

The filtering orifices may be formed in the filter media during creation of the filter media; inherent in the filter media material or combination of materials; formed as a result of one or more steps of the brewing process; or any combination thereof. For example, the filter media may be a continuous film, absent any filtering orifices during shipping and storage, and have the filtering orifices formed when the filter media contacts the brewing fluid. Alternatively, the filtering orifices may be formed in a continuous filter media by mechanical means applied to either side, such as piercing, tearing, puncturing, and combinations thereof. The orifices may also be formed by air pressure (e.g., blowing open or piercing the filter media material), water pressure, heat, lasers, electrical resistance, and the like.

As stated, the filtering orifices should be of sufficient size to allow the substantially unfettered passage of an extract solution, while simultaneously preventing the passage of a significant amount (i.e., in excess of 90%) of dispreferred insoluble particles. However, it is within the scope of the present invention that the orifices may have a variable geometry. This would depend on the force and/or pressure exerted against the portion of the filter media exposed to the extract solution, and the physical properties of the filter media material(s) selected (e.g., elasticity, tensile strength, and the like).

The filter media could be fashioned from one or more suitable filter media materials such that the filtering orifices would expand in size as pressure and/or force were applied. This would aide in the prevention of clogging, while simultaneously inhibiting the passage of a significant amount (i.e., in excess of 90%) of unacceptable particles and compounds.

In the fluidized brewing environment of the present invention the filter is of sufficient design and construction so as to withstand a pressure drop of less than about 15 psig, preferably less than about 10 psig, more preferably less than about 5 psig. During normal operations, pressure drops across the filter media during the extraction of ingredients will be less than about 5 psig, preferably less than about 3 psig, more preferably less than about 1.5 psig.

(v) Extraction Collection Chamber

The beverage brewing devices of the present invention may optionally comprise one or more extraction collection chambers. The optional extraction collection chamber is proximately or fluidly connected to the both the filter media and the ingredient extraction chamber.

The various containment walls of the extraction collection chamber may be comprised of a rigid, semi-rigid, or non-rigid material, including combinations thereof. The various containment walls of the extraction collection chamber may change their shape and/or rigidity, depending on the material selected.

The exact geometry (i.e., design) of the extraction chamber can be selected so as to aide in the formation of foam (e.g., through the use of mechanical impingement of the beverage extract) with a given set of foam characteristics (e.g., height, density, and the like) in the finished beverage composition.

(vi) Extraction Exit Site

The extraction exit site is a region or location on the housing where the finished beverage solution exits the beverage brewing device. The extraction exit site is proximately or fluidly connected to one or more extraction collection chambers.

The extraction exit site can either be formed by the beverage brewing system after introduction of the beverage brewing device to the beverage brewing system (e.g., by tearing, piercing, dissolving, crushing, pinching, bending, puncturing, and the like); formed during construction or assembly of the beverage brewing device and its components and subassemblies; formed by the user (e.g., by removal of a tear strip, puncturing, and the like); or by some combination thereof.

The exact geometry (i.e., orifice shape and size) of the extraction exit site can be selected so as to aide in the formation of foam, with a given set of foam characteristics (e.g., height, density, and the like), in the finished beverage composition. Suitable foam generation can also be accomplished by conjointly employing the extraction exit site geometry with a steam and/or liquid purge of the beverage brewing device at the end of the brewing cycle.

The steam and/or liquid purge momentarily increases the pressure inside the beverage brewing device to less than about 15 psig, preferably less than about 10 psig, more preferably less than about 5 psig. As the remaining purged ingredients exit the beverage brewing device they experience a pressure drop at the extraction exit site that accelerates their velocity and facilitates foam generation in the finished beverage. The purge also removes any additional extracted portions that remain trapped in the various components, chambers, assemblies, and sub-assemblies of the beverage brewing device.

During normal operation, the beverage brewing device experiences a pressure drop across the extraction exit site of less than about 5 psig, preferably less than about 3 psig, more preferably less than about 1 psig.

Preferably, the extraction exit site is of suitable design such that the finished beverage solution exits the beverage brewing device as droplets. Equally preferable are extraction exit sites that permit the finished beverage solution to exit the beverage brewing device as a continuous stream.

(vii) Fluid Bypass Conduit

The beverage brewing devices of the present invention may optionally comprise one or more fluid bypass conduits. The fluid bypass conduit is proximately or fluidly connected to the extraction exit site. The fluid bypass conduit is a channel, tube, conduit, chamber, and the like that permits the brewing fluid to pass from the fluid introduction site to the extraction exit site without having to pass through an ingredient extraction chamber.

(viii) Beverage Brewing Device Recognition System Components

The beverage brewing devices of the present invention may optionally comprise one or more beverage brewing device recognition system components. The beverage brewing device recognition system allows the beverage brewing system to recognize the presence, type and/or capabilities of the beverage brewing device inserted into the system by the consumer, without the need for the consumer to provide such information. For example, a beverage brewing device recognition system would recognize the exact type of beverage brewing device inserted (e.g., number of ingredient extraction chambers, orientation, and required flow path, and the like), recognize the ingredients contained therein (e.g., coffee, tea, creamy ingredients, combinations thereof, and the like), and identify and initiate the appropriate processing conditions required to achieve the desired finished beverage characteristics.

Suitable methods for recognition of the beverage brewing device include physical obstructions, voids, nodules, bumps, ridges, holes, recesses, protrusions, and the like, including combinations thereof. These physical recognition system components are preferably located on the beverage brewing device housing where, following insertion of the brewing device, they can interact with the recognition system components of the beverage brewing system (e.g., circuit switches). The combination of interactions indicate to the beverage brewing system the presence, type and/or capabilities of the inserted beverage brewing device.

Other suitable recognition system components for signaling to the beverage brewing system the type and capabilities of the inserted beverage brewing device include barcodes, magnetic strips, optical recognition, microchips, and the like, including combinations thereof. The type and capabilities of the beverage brewing device can be encoded into the recognition component of the device and read by a suitable corresponding component located on the beverage brewing system.

(ix) Flow Path

The flow path of the brewing fluid and the extraction through the beverage brewing device is generally characterized as either unidirectional or multidirectional. As used herein, the term “unidirectional flow path” is defined as passing through a beverage brewing device along a primary directional axis, without substantially reversing direction along that axis (i.e., the change in direction from the original vector of entry is less than about 100°). However, travel along a flow path that is not along the primary directional axis is acceptable (e.g., horizontal migration where the primary directional axis is vertical) as long as the flow path does not substantially reverse direction.

As used here, the term “multidirectional flow path” is defined as passing through the beverage brewing device along a primary directional axis, and at some point during fluid/extract migration experiencing a substantial reversal in direction along the primary axis (i.e., the change in direction from the original vector of entry is in excess of about 100°). However, travel along a flow path that is not along the primary directional axis is also acceptable (e.g., horizontal migration where the primary directional axis is vertical).

Take, for example, a beverage brewing device where the brewing fluid enters the brewing device at the vertical most point of the device and travels along a substantially vertical axis from top to bottom., subsequently exiting the brewing device at a point below the point of fluid introduction. A unidirectional flow path would be one where the fluid/extraction does not substantially reverse direction (though horizontal flow path segments (e.g., changes in direction of about 90° from the original vector of entry) are acceptable) and travels from substantially from the top of the beverage brewing device to the bottom. A multi-directional flow path would be one where the fluid/extraction experiences a substantial reversal in direction along the vertical axis (e.g., the flow path travels vertically from top to bottom and then reverses direction from bottom to top, in other words experiences a change in direction from the original vector of entry of about 180°).

Having now described the various parts, components, chambers, assemblies, and sub-assemblies of the beverage brewing device, one of ordinary skilled in the art will appreciate that the sequence and order of explanations is not intended to be limiting. The various combination and permutation of components, chambers, assemblies, and subassemblies of the instant beverage brewing devices is dependent on the desired finished beverage characteristics (e.g., strength, character, volume, beverage preparation time, optional ingredients, and the like).

### C. CUSTOMIZATION

The beverage brewing devices of the present invention optionally allow for customization of a final beverage's strength, character, volume, and combinations thereof. In general, customization of the finished beverage is accomplished by controlling such variables as brewing fluid flow rate, brewing fluid temperature, and fluid contact time with the beverage ingredients. Additionally, customization can be achieved by controlling the amount of ingredients exposed to the brewing fluid (e.g., providing multiple ingredient extraction chambers comprising fixed ingredient amounts) and the volume of brewing fluid that is allowed to pass through the ingredient extraction chamber(s), relative to the total liquid volume in the finished beverage (e.g., fluid bypass).

(i) Beverage Strength Control

The strength of brewed beverages prepared using the beverage brewing devices of the present invention are typically characterized as a function of the brew solids value. The brew solids value is an indication of the mass transfer that has occurred from the solid grounds to the water phase during brewing, and is simply the coffee solids remaining after oven drying the brewed coffee beverage.

The brew solids value is defined as the weight of coffee solids in an extract solution, divided by the total weight of the solution. This value is typically expressed as a percentage. The weight of the coffee solids is measured as the weight of materials that remain after oven drying the finished extract solution. The brew solids value may also be measured utilizing to the analytical method described hereinafter.

Analytical Method:

The brewed coffee beverage is placed in a 12 ml sealed vial and allowed to cool to a temperature of 29° C. The sample is then analyzed for solids content by the index of refraction method using a Bellingham & Stanley RFM 81, where the sample temperature during the measurement is maintained at 29° C. The readings are correlated with readings of reference solutions of known brew solids content based on oven drying techniques using a correlation of: Refractive Index=0.001785×(% brew solids)+1.331995.

Coffee compositions derived from the inventions herein preferably have a brew solids value in the range of from about 0.2 to about 1.5, more preferably in the range of from about 0.3 to about 1.2, more preferably in the range of from about 0.4 to about 1.0.

(i)(1) Multiple Ingredient Extraction Chambers

When brewing beverages with fixed quantities of brewing fluids (typically hot water in the temperature range of from about 150° F. to about 210° F.), customization of beverage strength (i.e., brew solids value) is accomplished by controlling the ratio of brewing fluid to extractable ingredient (e.g., coffee, tea, cocoa, and the like). With respect to coffee, the strength of a finished brewed coffee beverage may be increased by increasing the amount of coffee a fixed volume of brewing fluid passes through, relative to the fixed volume of brewing fluid. Likewise, by increasing the amount of brewing fluid relative to the amount of coffee, a beverage's strength may be decreased. Additional coffee can be provided in the beverage brewing devices of the present invention by providing additional ingredient extraction chambers comprising coffee ingredients.

For example, in one embodiment of the present invention a beverage brewing device comprising two ingredient extraction chambers is provided, each with a given volume of roast and ground coffee. The first ingredient extraction chamber contains from about 10% to about 50% of the total quantity of roast and ground coffee in the beverage brewing device. Preferably from about 35% to about 45%, more preferably about 40%. The second ingredient extraction chamber contains from about 50% to about 90% of the total quantity of roast and ground coffee in the beverage brewing device. Preferably from about 55% to about 75%, more preferably about 60%.

To make a finished brewed beverage of mild strength, substantially all (i.e., about 100%) of the brewing fluid is directed through the first ingredient extraction chamber containing 40% of the total coffee ingredients. To make a finished brewed beverage of average strength, substantially all (i.e., about 100%) of the brewing fluid is directed through the second ingredient extraction chamber containing 60% of the total coffee ingredients.

To make a finished brewed beverage of strong strength, the quantity of brewing fluid is divided between the two ingredient extraction chambers, wherein a first portion of the brewing fluid is directed to the first ingredient extraction chamber, and a second portion of the brewing fluid is directed to the second ingredient extraction chamber. Preferably the proportions of brewing fluid passing through the ingredient extraction chambers approximately correspond to the proportions of coffee ingredients in each ingredient extraction chamber. For example, in an embodiment where the total quantity of coffee ingredients is divided between two extraction chambers by the ratio of about 40% to about 60%, the first portion of brewing fluid passing through the first ingredient extraction chamber contains from about 10% to about 50% of the total quantity of brewing fluid. Preferably from about 35% to about 45%, more preferably about 40%. The second portion of brewing fluid passing through the second ingredient extraction chamber contains from about 50% to about 90% of the total quantity of brewing fluid. Preferably from about 55% to about 75%, more preferably about 60%.

One of ordinary skill in the art will appreciate that the number of different beverage strengths obtainable by way of the present invention is, in part, a function of the beverage brewing device's design and construction. The greater the number of ingredient extraction chambers provided, and the ability to appropriately direct portions of the brewing fluid to each chamber, the greater the number of beverage strength settings that can be provided.

(i)(2) Fluid Bypass

Customization of a beverage's strength in a finished brewed beverage may also be accomplished by providing a sufficient quantity of roast and ground coffee, in one or more ingredient extraction chambers, such that a fixed volume of brewing fluid passing through the roast and ground coffee ingredients will form a strong beverage. Depending on the finished beverage strength desired by the consumer the finished beverage can be diluted to the desired beverage strength (e.g., average, mild, and the like).

Dilution of the finished beverage may occur through use of a fluid bypass conduit, or other such means, incorporated into the beverage brewing device. A fixed volume of brewing fluid passes through the ingredient extraction chamber to deliver a given brew solids value. An additional volume of fluid bypasses the ingredient extraction chamber, passing through the beverage brewing device to the finished beverage container, and dilutes the finished beverage to the desired strength.

(ii) Beverage Character

As used herein, the term “beverage character” is defined as the extraction yield of the finished beverage. The extraction yield is defined as the weight of coffee solids in solution divided by the total weight of starting coffee ingredients (e.g., roast and ground coffee). This value is typically expressed as a percentage.

Preferred extraction yield values for beverages prepared from the methods and beverage brewing devices of the present invention are greater than about 10, more preferably greater than about 15, more preferably greater than about 20.

An alternative method of expressing beverage character is as the difference between the extraction yield achieved using the brewing method and apparatuses of the present invention, and a standard brewing method. This measure is often called a delta yield.

Delta yield is herein defined as the difference between the present extraction yield (as calculated above) and a standard extraction yield from the standard brewing method described below. Preferred delta yield values for beverages prepared from the methods and beverage brewing devices of the present invention are less than about 20%, more preferably less than about 15%, more preferably less than about 10%, more preferably less than about 5%, most preferably less than about 3%.

Standard Brewing Method:

Coffee is brewed on a Bunn OL-35 automated drip brewer. Coffee filters are 12 cup oxygen processed Bunn Coffee filters (Reg. 6001). A weight of one ounce of coffee is added to the filter in the basket. The brewer is supplied with distilled water and feeds 1860 ml at 195° F. (90° C.) in 146 seconds to the brew basket. Brewed coffee is collected in a carafe and then mixed. Samples for the standard extraction yield are then collected and analyzed.

For a given set of ingredient characteristics (e.g., ingredient size, shape, degree of agglomeration, and the like) there are two primary methods for varying the extraction yield. The first method is to adjust the temperature of the brewing fluid. Preferred temperatures for the brewing fluid are in the range of about 150° F. to about 210° F. The greater the temperature of the brewing fluid, the higher the degree of extraction (i.e., the higher the extraction yield value, and the lower the delta yield value).

The second method for varying the degree of extraction is to adjust the time the brewing fluid is in contact with the beverage ingredients. The longer the extraction contact time, the higher the degree of extraction (i.e., the higher the extraction yield value, and the lower the delta yield value). The extraction contact time can be varied by design of the ingredient extraction chamber geometry, by alteration of the filter media area, by adjustment of the brewing fluid flow rate, and combinations thereof.

The geometry of the ingredient extraction chamber can be designed and constructed so as to retain the brewing fluid during the extraction phase for a greater or lesser amount of time. Additionally, the total filter area of the beverage brewing devices of the present invention can be adjusted either upwards or downwards to increase or decrease the extraction contact time. Finally, the flow rate of the brewing fluid can be increased or decreased to adjust extraction contact time.

(iii) Beverage Volume

Typically the liquid volume of the finished beverage will be about equal to the volume of brewing fluid that passed through the ingredients in the ingredient extraction chamber(s), less any amount that remains trapped within the ingredients and other components, compartments, assemblies, and sub-assemblies of the beverage brewing device. The total liquid volume of the finished beverage, however, may also comprise a liquid volume portion that has bypassed the ingredient extraction chamber. This would allow the consumer to create a variety of beverage sizes.

Adjustment of the finished beverage volume in isolation would have a corresponding effect on the beverages strength, as described herein. However, the customization methods previously described could be conjointly employed to overcome this effect. By way of example, a consumer may desire and select the beverage brewing system to deliver a larger volume finished beverage. In isolation, this customization would decrease the strength of the finished beverage. To compensate for this, additional ingredient extraction chambers could be employed to compensate for the reduction in beverage strength. Additionally, the temperature of the brewing fluid and/or the extraction contact time could be adjusted to vary the finished beverage's character.

While customization is a distinct advantage of the present invention, beverage brewing devices having a plurality of extraction chambers have utility independent of the use of the instant customization techniques. Accordingly, the customization options disclosed herein are not required applied to produce a beverage brewing device within the scope of Applicants' present invention.

### D. BEVERAGE BREWING SYSTEM

Existing beverage brewing systems known in the art suffer from many disadvantages that have limited there utility in the preparation of cafe quality, convenient, customizable brewed beverages. As such, existing brewing systems known in the art have met with limited consumer acceptance, resulting from system designs that are too costly and complex for the occasional and/or at home user. Examples of such systems can be found in U.S. Pat. No. 4,724,752 to Aliesch et al. and U.S. Pat. Nos. 4,873,915 and 4,920,870 to Newman et al.

Attempts to address disadvantageously high system complexity have also met with limited success in the art as a result of compromising customizability and convenience. Examples of such attempts can be found in U.S. Pat. No. 6,009,792 to Diederik Kraan, and U.S. Pat. No. 5,325,765 to Sylvan et al.

Therefore, the beverage brewing systems of the present invention are designed to obviate these shortcomings and provide an inexpensive, simple, convenient and easy to use brewing system for the preparation of single serving size portions of customizable brewable beverages.

(i) Basic Components

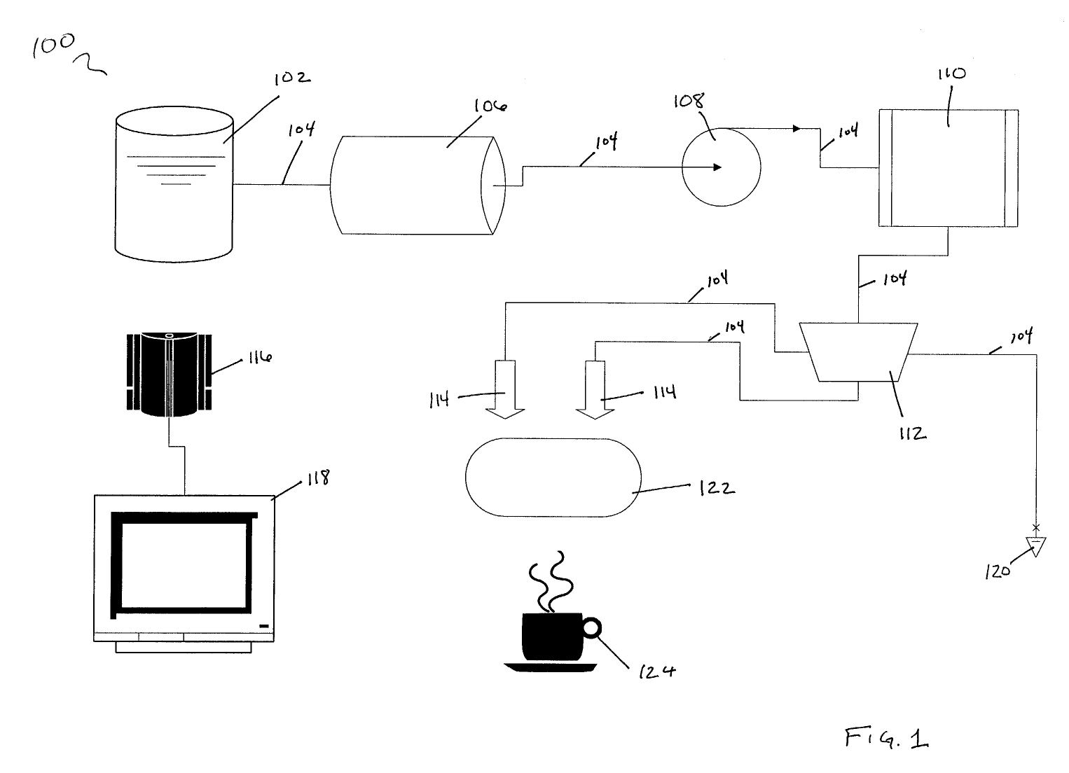

Referring to FIG. 1, the basic components of the present beverage brewing system will now be described.

The beverage brewing systems of the present invention comprise a brewing fluid reservoir 102. The brewing fluid is preferably water. The reservoir is designed and constructed to hold a sufficient amount of brewing fluid for at least one portion of a prepared beverage. Preferably, the reservoir will hold a sufficient amount of brewing fluid (2-20 portions worth) so as eliminate the inconvenience of repeatedly refilling the reservoir after each use of the system.

The beverage brewing system may optionally contain a brewing fluid purification device 106. Such devices include filters, chemical purification devices, and the like. A system pump 108 is used to draw fluid from the reservoir 102, through supply line 104, to the remaining components of the beverage brewing system. Suitable pumping devices include, but are not limited to, piston, diaphragm, pressurized head system, and peristaltic pumping mechanisms.

The pumping device 108, pumps fluid through supply line 104 to a fluid heating device 110. Heater 110 heats the brewing fluid to a sufficient temperature (preferably from about 150° F. to about 210° F.) to enable proper extraction and/or solubilization of the ingredients contained in the beverage brewing device.

From heating unit 110, the brewing fluid travels through supply line 104 to a fluid directing device 112. The fluid directing device directs water to one or more fluid insertion devices 114. The exact number of fluid insertion mechanisms is dictated by the design and functional requirements of the beverage brewing device 122. For example, beverage brewing devices with multiple (i.e., more than one) fluid introduction sites to enable brew strength control (e.g., via multiple ingredient extraction chambers and/or fluid bypass) would require multiple fluid introduction mechanisms.

It is within the scope of the present invention, as will be appreciated by one of ordinary skill in the art, that an quantity of fluid introduction mechanisms may be provided on the beverage brewing system to accommodate numerous beverage brewing devices, and not all would be utilized in each operation of the system. Control of the fluid directing device can be accomplished by system controller 116, or alternatively, and equally preferable by leavers, knobs, switches, servos, valves and other such suitable mechanisms.

Fluid directed to one or more fluid introduction devices 114 enters beverage brewing device 122. The fluid then passes through the various compartments, passages, channels, conduits, components, assemblies, and sub-assemblies of beverage brewing device 122 and exits directly into cup 124, ready to be consumed.

System controller 116 controls the various functions of the beverage brewing system. Such functions include, but are not limited to, fluid flow rate, fluid temperature control, direction of brewing fluid to one or more fluid introduction mechanisms, fluid introduction, and the like. System controller 116 also controls various feedback control systems for ensuring appropriate heating profiles, pump operation for appropriate brewing fluid flow, and the like.

It will be appreciated by one skilled in the art that system control 116 is described as single operating unit solely for the convenience of the reader, and such description is not intended to be limiting. In various embodiments of the present invention it is contemplated that system controller 116 be comprised of one or more system controlling devices including, but not limited to, electrical, mechanical, software, and the like, including combinations thereof.

System controller 116 is connected to user interface 160. User interface 160 is device or set of devices that enable the consumer to select the desired characteristics of the finished, ready to drink, brewed beverage product. User interface 160 can be any form of suitable device including, but not limited to, knobs, levers, switches, buttons, dials, keys, and the like, including combinations thereof. It alternate embodiments of the present invention the user interface is a graphical user interface comprising user interface software and corresponding display hardware. It is also contemplated that user interface 160 can be a combination of electrical, mechanical, software devices, and the like, including combinations thereof.

A system user selects one or more desired finished beverage characteristics (depending on the capabilities of the beverage brewing system and intended beverage brewing device) via user interface 160. System controller 116 then controls the various components of the beverage brewing system to deliver the brewing fluid contained in reservoir 102 to beverage brewing device 122. System controller 116 controls the various components of the beverage brewing system to ensure that the brewing fluid delivered to the brewing device has the necessary characteristics (temperature profile, fluid volume, fluid flow rate, and the like) to allow the beverage brewing device to generate the desired beverage.

Optionally. The beverage brewing system may contain a heated fluid supply device 120, separate and distinct from the fluid insertion mechanism.

(ii) Brewing Fluid Introduction

The fluid introduction mechanisms 114 of the present invention are designed to insert the brewing fluid from the beverage brewing system 100 to the beverage brewing device 122 at one or more fluid introduction sites. In one embodiment of the present invention the fluid introduction mechanism 114 is a needle that punctures the housing of the beverage brewing device 122 at the fluid introduction site.

In this embodiment the puncturing of the needle occurs as the beverage brewing device 122 is inserted into the beverage brewing system 100. The fluid introduction mechanisms 114 may optionally be fixed to the beverage brewing system 100 such that the brewing device 122 is forced into contact with the introduction mechanisms 114 upon insertion into the system (e.g., needles mounted to the system's housing).

In another embodiment, the fluid introduction mechanism 114 is movable and comes into contact with the fluid introduction site by a mechanism driven by the mechanical force provided by the act of insertion. In such an embodiment, the fluid introduction mechanism 114 comes in contact with the brewing device 122 upon insertion into the brewing system 100, and is disconnected from the device 122 upon removal of the brewing device from the system.

In another embodiment of the present invention, the fluid introduction mechanism 114 is a needle. Attached to the needle is a gasket or flange that enables the formation of contact seal between the beverage brewing device 122 and the fluid insertion mechanism 114. Upon removal of the needle from the brewing device 122 the housing of the device cleans the needle, aiding in the preservation of brewing system hygiene.

(iii) Beverage Brewing Device Recognition System

The beverage brewing systems of the present invention may optionally comprise one or more beverage brewing device recognition system components. The beverage brewing device recognition system allows the beverage brewing system to recognize the presence, type and/or capabilities of the beverage brewing device inserted into the system, without the need for the consumer to provide such information. For example, a beverage brewing device recognition system would recognize the presence of a beverage brewing device, thereby inhibiting the activation of a brewing system safety feature that prohibits system operation when a beverage brewing device is not present, or is improperly inserted. A recognition system may also detect the exact type of beverage brewing device inserted (e.g., number of ingredient extraction chambers, orientation, and required flow path, and the like), recognize the ingredients contained therein (e.g., coffee, tea, creamy ingredients, combinations thereof, and the like), and identify and initiae the appropriate processing conditions required to achieve the desired finished beverage characteristics.

Recognition of the capabilities of the beverage brewing device could be accomplished by looking-up the brewing devices capabilities in a remote or proximately located database, thereby allowing the database to be updated as new properties are made available to the brewing device. Recognition of capabilities could also be accomplished by reading such data from the device itself, or the programming, adjustment, movement, activation, or deactivation of mechanical switches and/or electrical circuits on the beverage brewing system. A combination of such approaches could also be employed.

Suitable methods for recognition of the beverage brewing device include physical obstructions, voids, nodules, bumps, ridges, holes, recesses, protrusions, and the like, including combinations thereof. These physical recognition system components are preferably located on the beverage brewing device housing where, following insertion of the brewing device, they can interact with the recognition system components of the beverage brewing system (e.g., circuit switches). The combination of interactions indicate to the beverage brewing system the type and capabilities of the inserted beverage brewing device.

Other suitable recognition system components, for signaling to the beverage brewing system the type and capabilities of the inserted beverage brewing device, include barcodes, magnetic strips, optical recognition, microchips, and the like, including combinations thereof. The type and capabilities of the beverage brewing device can be encoded into the recognition component of the device and read by a suitable corresponding component located on the beverage brewing system.

The following examples further describe and demonstrate embodiments within the scope of the present invention. These examples are given solely for the purpose of illustration and are not to be construed as a limitation of the present invention, as many variations thereof are possible without departing from the invention's spirit and scope.

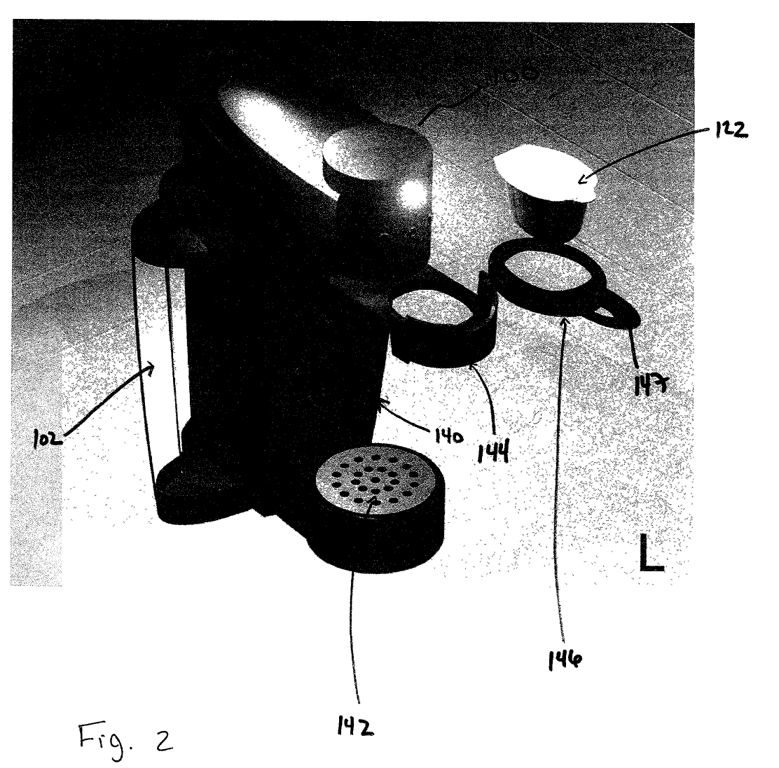

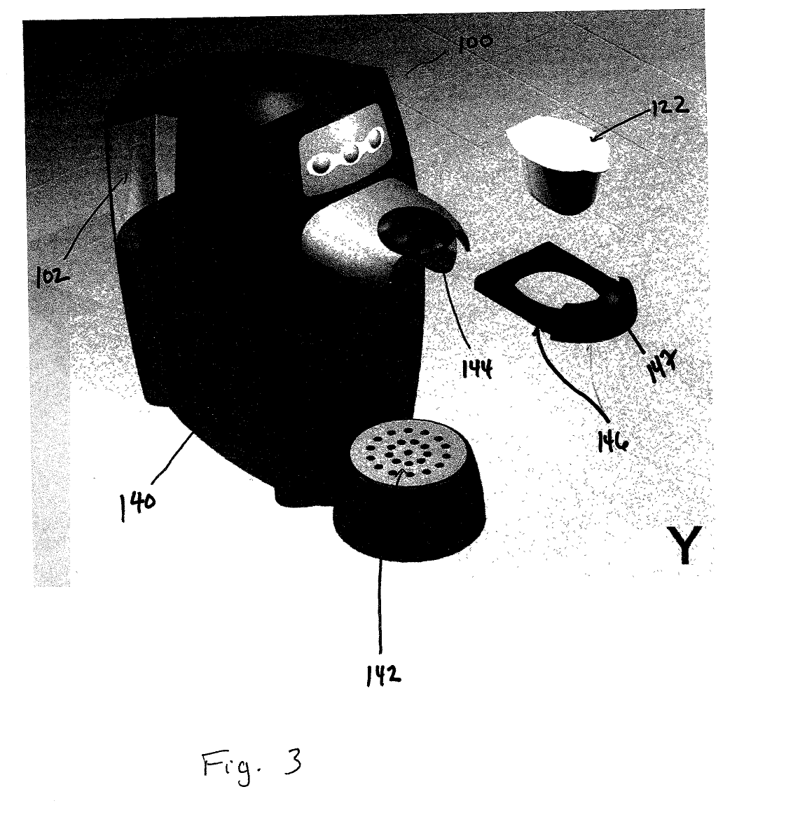

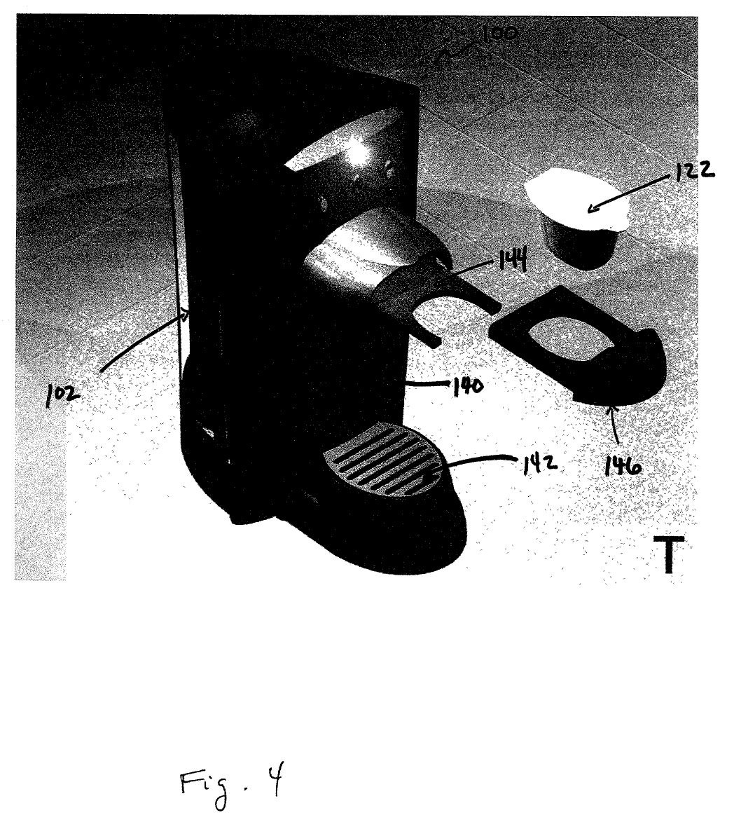

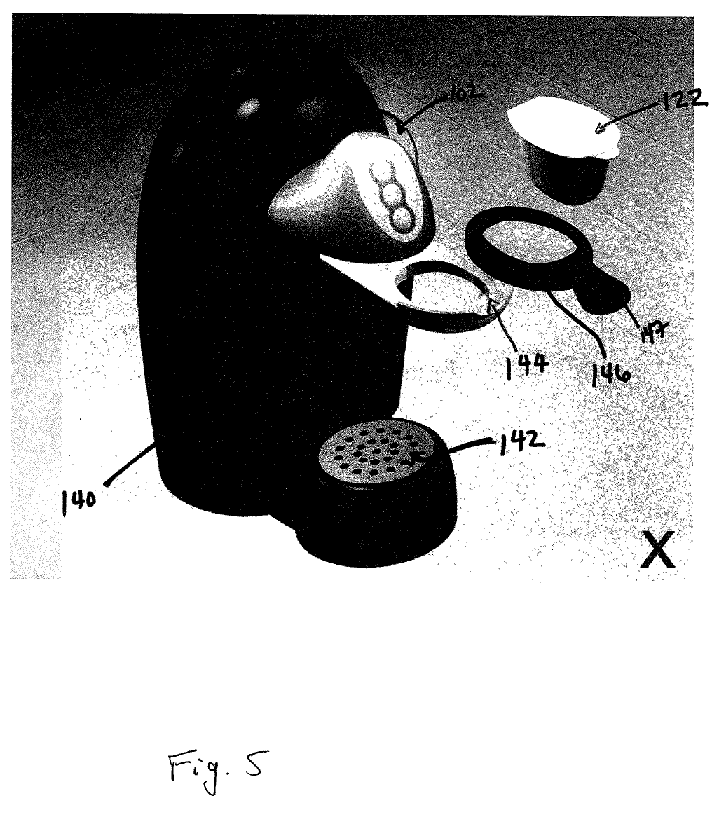

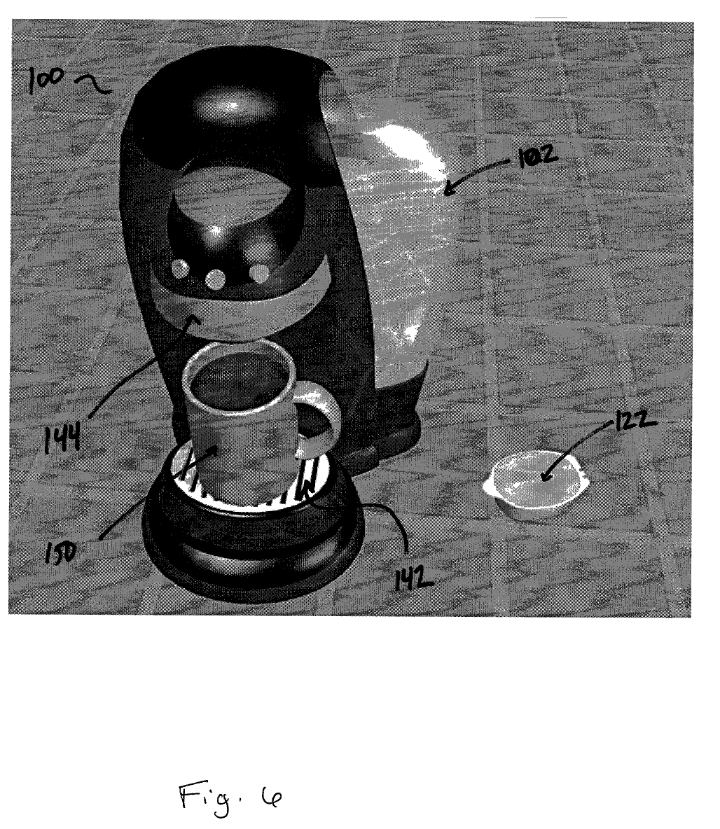

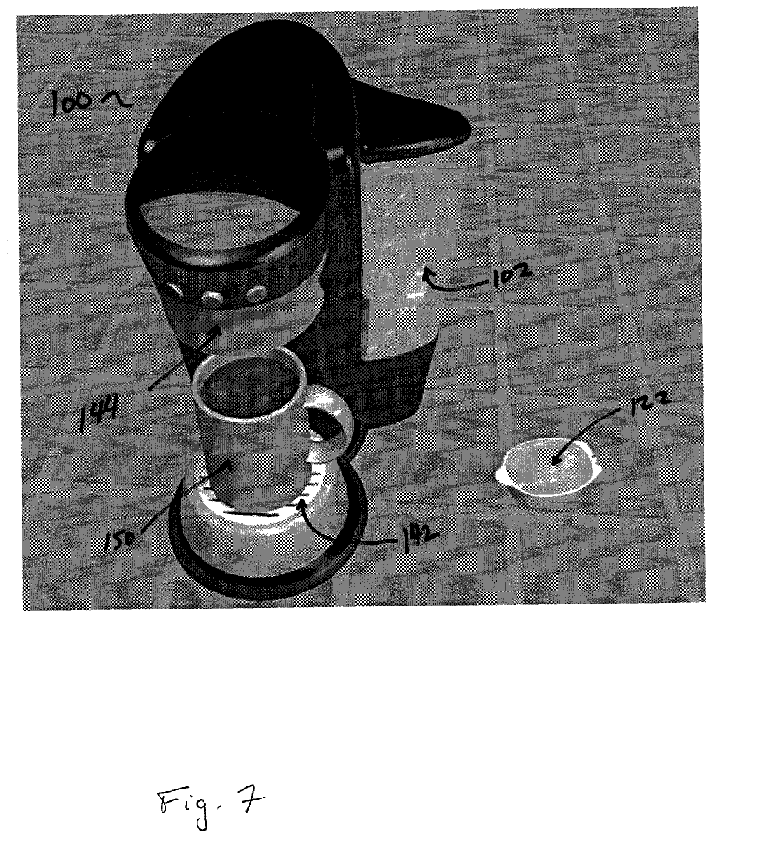

FIGS. 2-7 are perspective views of various embodiments of the beverage brewing system 100 of the present invention. With respect to those figures brewing system 100 is provided with a brewing fluid reservoir 102. Reservoir 102 may be detachable, or permanently affixed to brewing system 100. System 100 has housing 140 and beverage container base 142 for receiving and supporting a beverage container 150 during system operation and beverage preparation. Beverage brewing device 122 is supported during system operation by a removable brewing device tray 146. Removable brewing device tray 146 is in turn mated to and supported by tray support 144, during system operation, which is connected to system 100. In use, brewing device 122 is placed into or onto tray 146, depending on the exact configuration of the brewing device and the tray. The tray and device combination is then mated to tray support 144 and inserted within housing 140. Insertion may be accomplished by either manual means, automatic means, or combinations thereof. A brewed beverage is then prepared, upon completion of which supporting tray 144 is uninserted from housing 140. The combination of tray 146 and brewing device 122 is then unmated from supporting tray 144. In preferred embodiments of the present invention tray 146 comprises a handle area 147 by which the user may grip tray 146 and conveniently load and unload beverage brewing devices 122.

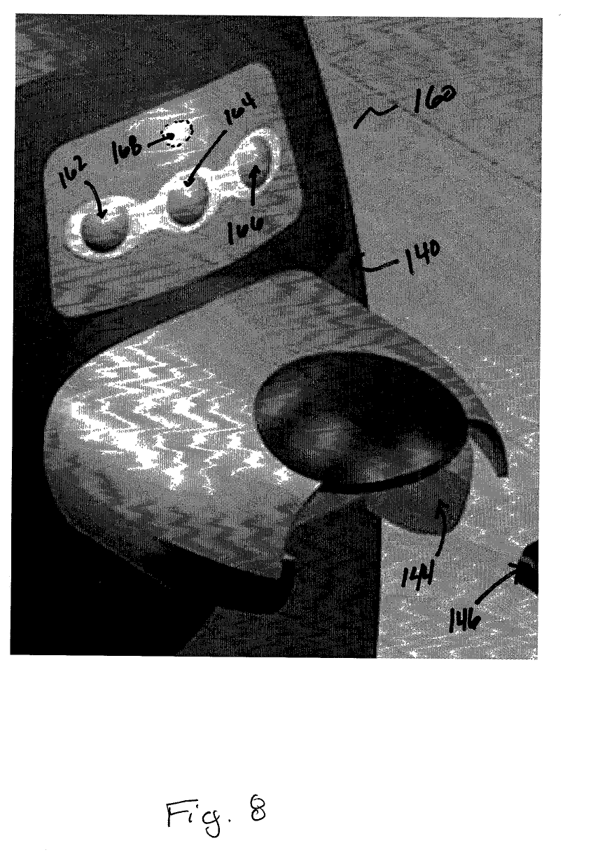

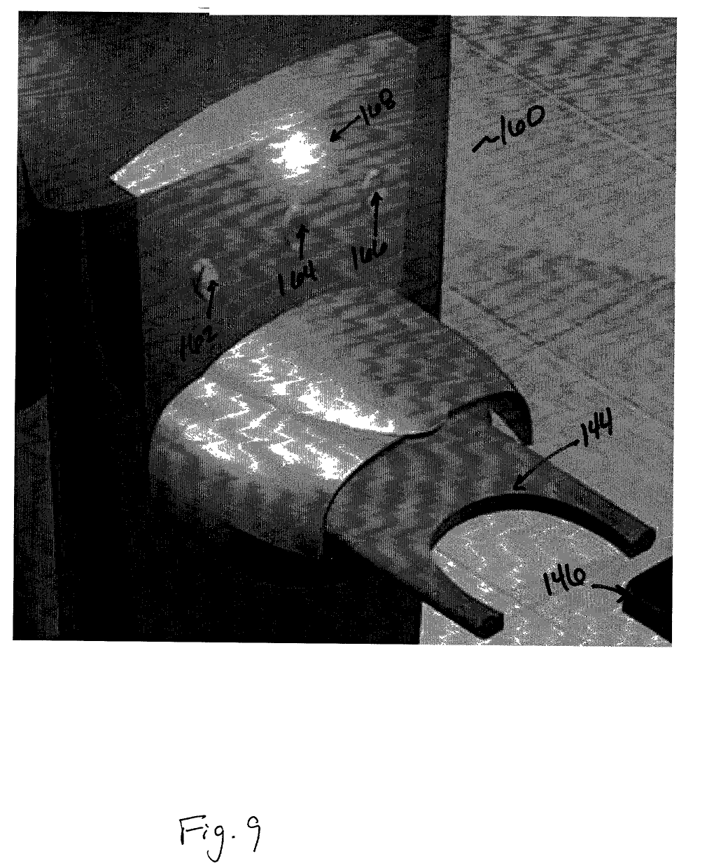

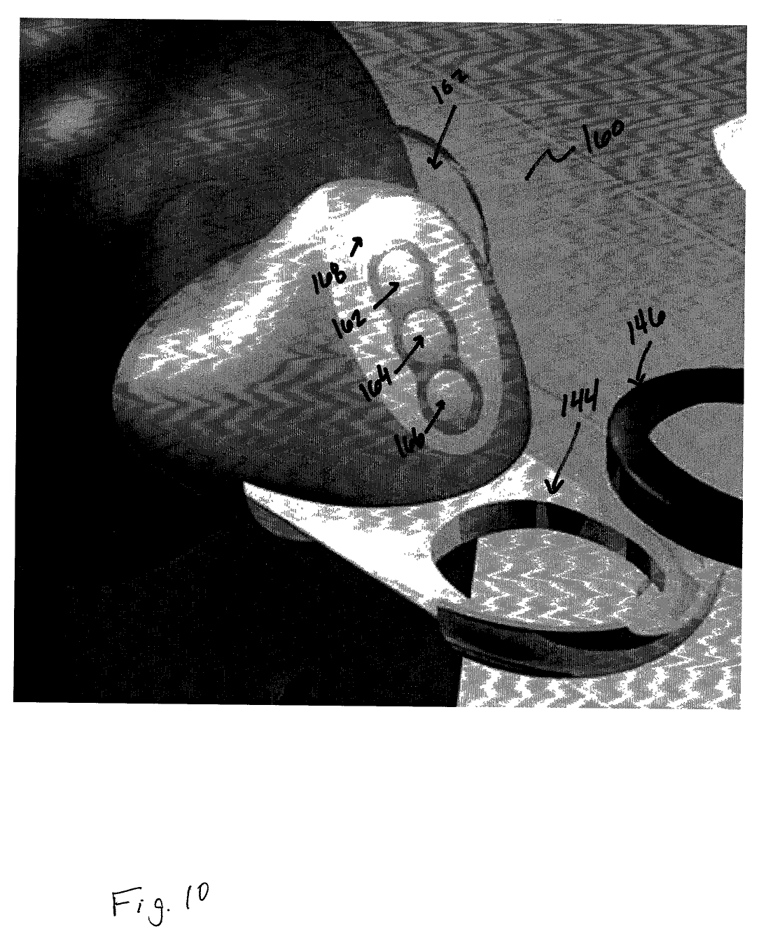

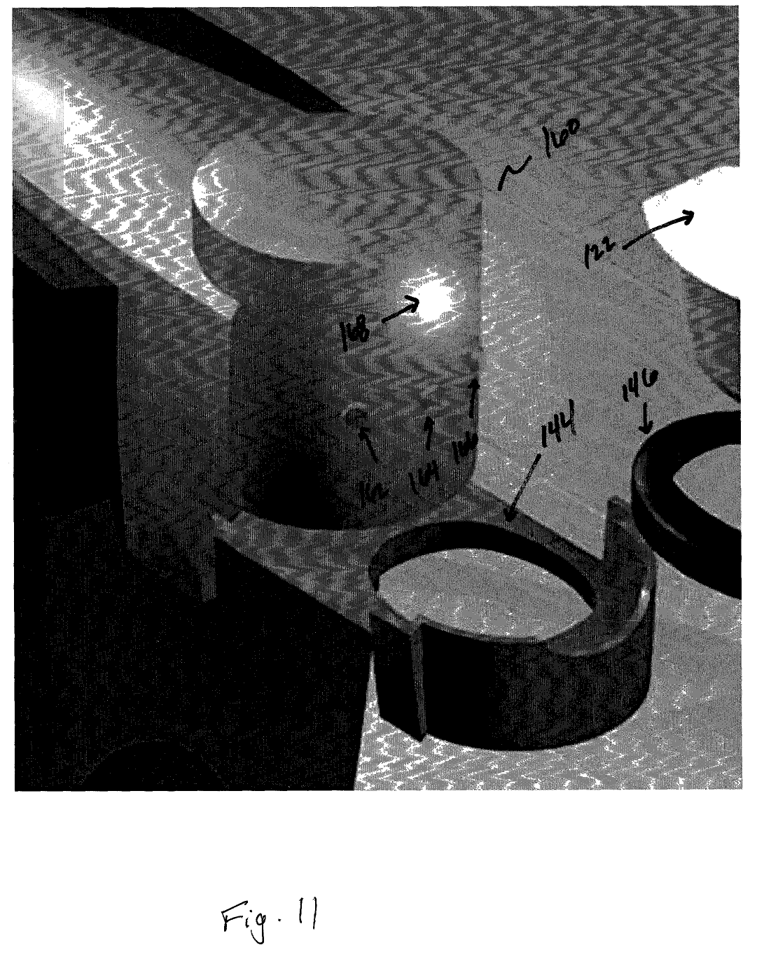

FIGS. 8-11 are perspective views of various user interface areas 160 located on housing 140 of beverage brewing system 100. Alternatively, the user interface area may be remotely or proximately located to brewing system 100, depending on the exact configuration and intended operation of system 100. In these embodiments user interface area 160 comprises a power activation and status indicator 168 which allows the user to activate brewing system 100, and communicates system on/off status to the user. In brewing systems capable of beverage customization, user interface area 160 additionally comprises beverage customization activation and indicator mechanisms 162, 164, and 166, by which the user may select and receive information concerning the particular beverage customization options available. In one embodiment a first, second, and third customization activation mechanism is provided corresponding to a mild, average, or strong brew strength, respectively. The user, by selecting a particular customization activation mechanism, determines the strength of the final beverage that will be prepared by system 100 from beverage brewing device 122. Optionally, and preferably, one or more customization activation mechanism indicators is provided to allow system 100 to communicate the particular customization characteristics available to, and selected by the user.

Having now described several embodiments of the present invention it should be clear to those skilled in the art that the forgoing is illustrative only and not limiting, having been presented only by way of exemplification. Numerous other embodiments and modifications are contemplated as falling within the scope of the present invention as defined by the appended claims thereto.

What is claimed is:

1. A beverage brewing system capable of providing a single serving portion of a fresh brewed creamy coffee beverage comprising:
a) a brewing fluid reservoir;
b) a brewing fluid pump;
c) a brewing fluid heater;
d) a brewing fluid directing mechanism;
e) one or more brewing fluid insertion devices;
f) a system controller; and,
g) a user interface,
wherein said beverage brewing system prepares a brewed beverage from a beverage brewing device.

2. The beverage brewing system of claim 1 further comprising a brewing fluid purification device.

3. The beverage brewing system of claim 1 further comprising a separate heated fluid supply mechanism.

4. The beverage brewing system of claim 1 wherein said user interface comprises at least one customization activation mechanism.

5. The beverage brewing system of claim 4 wherein for each of said customization activation mechanisms there is a corresponding customization activation mechanism indicator.

6. The beverage brewing system of claim 5 wherein said user interface comprises from 2 to 6 of said customization activation mechanisms and corresponding said customization activation mechanism indicators.
